(19) United States
(12) Patent Application Publication
(10) Pub. No.: US 2012/0205132 A1
(43) Pub. Date: Aug. 16, 2012

(54) LIGHT SINGLE-BUTTON MULTIFUNCTIONAL ELECTRIC HAMMER

(76) Inventor: Wenjiang Wang, Jinhua (CN)

(21) Appl. No.: 13/502,400

(22) PCT Filed: Mar. 10, 2010
(86) PCT No.: PCT/CN10/70975

§ 371 Date: Apr. 17, 2012

(51) Int. Cl. B25D 11/08; B25F 3/00

(52) U.S. Cl. 173/48

(57) ABSTRACT

A light single button multi-function electric hammer comprises a body, a motor, a rotation set assembly (1), a cylinder assembly (6), a torque spring (2), a knob (26), a gearwheel and a transmission mechanism of torque clutch. The transmission mechanism of torque clutch comprises a pinion (7), a gear clutch (8), a middle shaft (10), a hammer crosspiece clutch (9), a swing rod bearing (11) and a primary gear (12). The pinion is movably fitted with the middle shaft; the pinion meshes the large end teeth of the gearwheel and matches with the inner teeth of the gear clutch. The gear clutch meshes the small end teeth of the gearwheel and is fitted with the teeth shaft of the middle shaft. The gear clutch and the hammer crosspiece clutch are movably fitted with the teeth shaft of the middle shaft. The swing rod bearing is movably fitted with the middle shaft and is connected with the cylinder assembly through the swing rod. Matched concavo and convex slots are set on the hammer crosspiece clutch and swing rod bearing. The primary gear is tightly fitted with the middle shaft. The knob is connected with an operating mechanism linked to the large teeth end of the gearwheel, the gear clutch and the hammer crosspiece clutch. The electric hammer enables a simple and compact structure, flexible and convenient conversion, low cost, safe and reliable use.

### FIELD OF THE INVENTION

The present invention relates to an electric tool, and more specially relates to a multifunctional electric hammer.

### DESCRIPTION OF THE PRIOR ART

With the development of the industry of power tools, people have more and more demand for the functions of power tools than ever. The four functions of electric hammer, comprising single hammering, single drilling, hammer drilling and single hammer angle adjustment, are well received by many users. However, slow single drilling speed has always been a shortcoming of electric hammers. Although the functions of an electric hammer can be switched with one button, yet it is difficult to achieve these functions because of its complicated structure, high manufacturing cost and short service life. It is inconvenient for operators to use the single drilling function because of the slow rotational speed under the condition of unchanged gear ratio.

### SUMMARY OF THE INVENTION

Accordingly, in order to overcome the above shortcomings of the complicated structure, high manufacturing cost and short service life existed in electric hammers occurring in the related art, a first object of the present invention is to provide a light single-button multifunctional electric hammer with a simple and reasonable structure, an easy and flexible function switch, low cost, safe and reliable performance.

The technology scheme of the present invention to solve relevant problems is as follows:

A light single-button multifunctional electric hammer comprises a hammer body, a motor, a rotary bush assembly, a cylinder assembly, a fork assembly and knobs. The motor, rotary bush assembly, cylinder assembly and fork assembly are installed in the hammer body. The knobs and paddle shifter assembly are interlocked. The light single-button multifunctional electric hammer also comprises a bull gear and a transmission mechanism. The bull gear comprises heel teeth and toe teeth. The heel teeth take the form of heel multi gear. The toe teeth take the form of toe few gear. The torque clutch transmission gear comprises a pinion, a gear clutch, a middle shaft, a hammering gear clutch, a swing rod bearing and a primary gear. The pinion and middle shaft movably fit. The pinion is engaged with the heel teeth of the bull gear and is engaged with inner gear of the gear clutch. The gear clutch is fitted with the toe teeth of the bull gear and middle shaft. The gear clutch and hammering gear clutch are fitted with the middle shaft. The swing rod bearing is movably fitted with the middle shaft and is connected to cylinder assembly through the swing rod. The hammering gear clutch and the swing rod bearing are provided with mating concave convex grooves, and the primary gear and the middle shaft fit closely. The knob is connected to an operating mechanism. The operating mechanism is fitted with heel teeth of bull gear, the gear clutch and the hammering gear clutch.

The operating mechanism comprises a stop plate spring, a stop plate, a drilling gear paddle shifter, a paddle shifter support, inner knobs, a hammering gear paddle shifter, a tension spring, a paddle shifter spring and a guide pillar. The stop plate spring, stop plate, drilling gear paddle shifter, paddle shifter support, hammering gear paddle shifter and tension spring are sequentially installed on the guide pillar in order. The stop plate is provided with stop teeth to match heel teeth of bull gear and is positioned on one side of inner knob. The other side of drilling gear paddle shifter is snapped on the paddle shifter support. A tension spring is provided between drilling gear paddle shifter and paddle shifter support. The other side of paddle shifter support is snapped on the hammering gear paddle shifter. A paddle shifter spring is provided between paddle shifter support and hammering gear paddle shifter. The paddle shifters of drilling gear paddle shifter are provided correspondingly on each side of gear clutch to clamp gear clutch. The hammering gear fork of hammering gear paddle shifter is provided correspondingly in the groove of hammering gear clutch.

To make the accurate function switch, the knob is provided on one side with an elliptical paddle shifter diverged from knob center. The elliptical paddle shifter is provided between paddle shifter support and hammering gear clutch, and also provided with a quadrant lug. A semicircular lug is provided on the other side with its outer edge supporting the positioning plate of stop plate.

To prevent overload running, needle radial positioning is adopted between the torque clutch and the rotary bush. The bull gear is movably fitted with the rotary bush. The torque clutch and bull gear are provided with concave convex grooves integrally.

After adopting the above structure, the knob coordinates with stop plate, paddle shifter support and hammering gear paddle shifter in various conditions through elliptical paddle shifter, quadrant lug and semicircular lug. The paddle shifter support drives the drilling gear paddle shifter to enable the gear clutch to be disengaged with the pinion and engaged with toe teeth of bull gear. The hammering gear paddle shifter drives the hammering gear clutch to disengage with the swing rod bearing. Thus, the electric hammer can realize smooth shift among five functions: single drilling 1, single drilling 2, single hammering, hammer drilling and single hammer angle adjustment.

Through torque spring, the bull gear is fitted with convexo-concave grooves of the torque clutch and is disengaged when overloading in the function of hammering and drilling, single drilling 1 and single drilling 2. It is characterized by simple structure, flexible and convenient switch, low cost, safe and reliable performance.

The benefits of the present invention are characterized by simple and reasonable structure, flexible and convenient switch, low cost, safe and reliable performance.

### BRIEF DESCRIPTION OF THE DRAWINGS

FIG. 1 is a schematic drawing showing the structure of the present invention.

FIG. 2 is a schematic drawing of hammering and drilling of the present invention.

FIG. 3 is a schematic drawing showing the co-operation between knobs and operating mechanism in hammering and drilling of the present invention.

FIG. 4 is a schematic drawing showing the co-operation between bull gear and pinion and the blade of gear of the present invention.

FIG. 5 is a schematic drawing showing the structure of the single drilling 1 of the present invention.

FIG. 6 is a schematic drawing showing the co-operation between knobs and operating mechanism of drilling 1 of the present invention.

FIG. 7 is a schematic drawing showing the structure of the single drilling 2 of the present invention.

FIG. 8 is a schematic drawing showing the co-operation between knobs and operating mechanism of drilling 2 of the present invention.

FIG. 9 is a schematic drawing showing the structure of single hammering of the present invention.

FIG. 10 is a schematic drawing showing the co-operation between knobs and operating mechanism of single hammering of the present invention.

FIG. 11 is a schematic drawing showing the structure of single hammer angle adjustment of the present invention.

FIG. 12 is a schematic drawing showing the co-operation between knobs and operating mechanism of single hammer angle adjustment of the present invention.

FIG. 13 is a schematic drawing showing the structure of bull gear of the present invention.

FIG. 14 is a schematic drawing showing the structure of gear clutch of the present invention.

FIG. 15 is a schematic drawing showing the structure of hammering gear clutch of the present invention.

FIG. 16 is a schematic drawing showing the structure of swing rod bearing of the present invention.

FIG. 17 is a schematic drawing showing the structure of swing rod bearing knob of the present invention.

### DETAILED DESCRIPTION OF THE PREFERRED EMBODIMENTS

Reference will now be made in greater detail to exemplary embodiments of the invention with reference to the accompanying drawings.

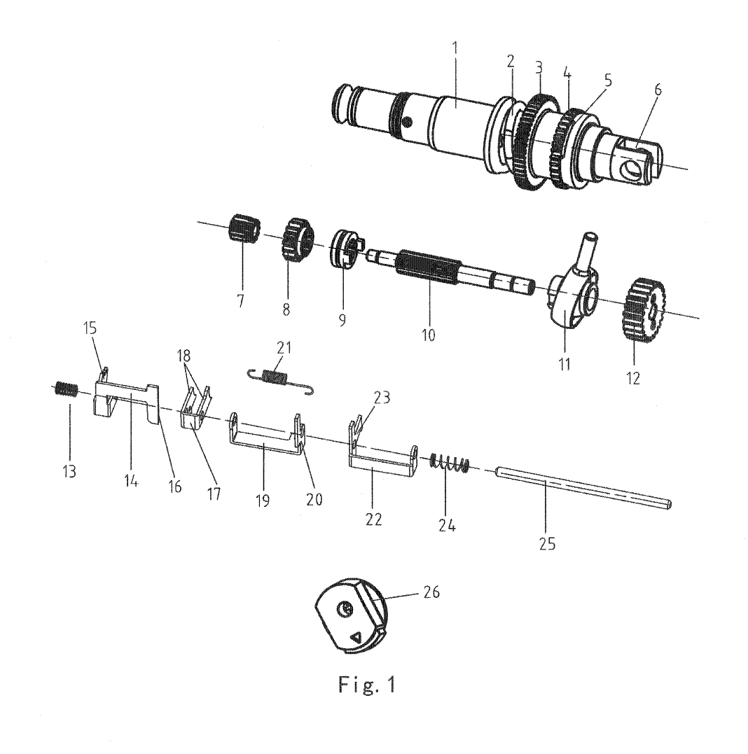

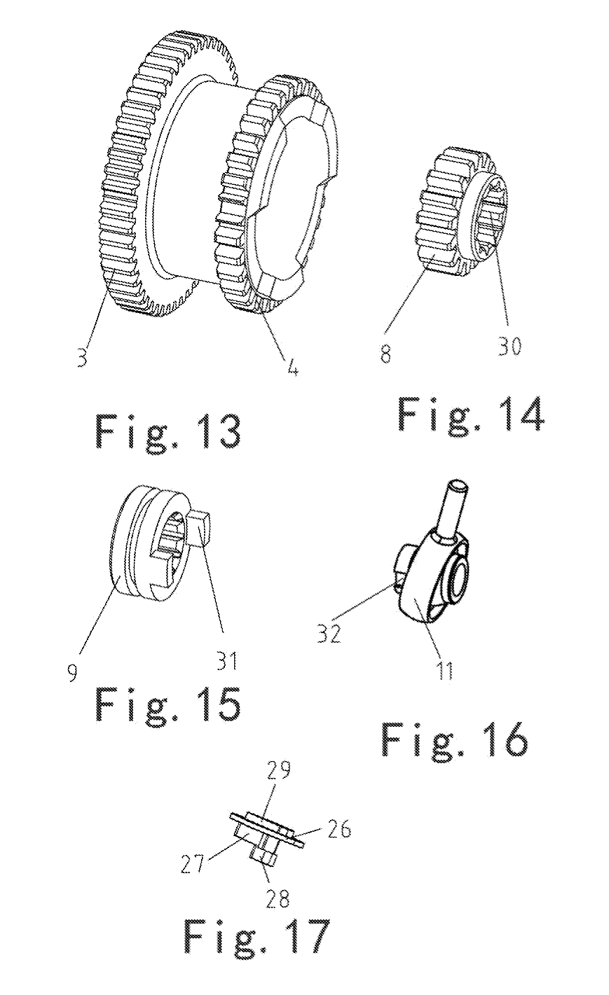

With reference to FIG. 1 to FIG. 17, a light single-button multifunctional electric hammer comprises a hammer body, a motor, a rotary bush assembly (1), a cylinder assembly (6), a torque spring (2), a bull gear (the bull gear consists of two parts: one part is heel multi teeth, short for heel teeth (3); the other part is toe few teeth, short for toe teeth (4).), a torque clutch (2), a transmission mechanism and knobs (26). The transmission mechanism comprises a pinion (7), a gear clutch (8), a middle shaft (10), a hammering gear clutch (9), a swing rod bearing (11) and a primary gear (12). The pinion (7) is movably fitted with middle shaft (10), is engaged with heel teeth (3) of bull gear and is fitted with inner gear of gear clutch (8). The gear clutch (8) is engaged with toe teeth (4) of bull gear. The gear clutch (8) and hammering gear clutch (9) are fitted with the gear shaft of middle shaft (10). The swing rod bearing (11) is movably fitted with middle shaft (10) and is connected to cylinder assembly (2) through the swing rod. The hammering gear clutch (9) and swing rod bearing (11) are provided with mating concave convex groove. The primary gear (12) is movably fitted with middle shaft (10). The knob (26) is connected to operating mechanism. The operating mechanism is interlocked with heel teeth (3) of bull gear, gear clutch (8) and hammering gear clutch (9).

The operating mechanism comprises a stop plate spring (13), a stop plate (14), a drilling gear paddle shifter (17), a paddle shifter support (20), a hammering gear paddle shifter (23), a tension spring (12), a paddle shifter spring (21) and a guide pillar (25). The stop plate spring (13), stop plate (14), drilling gear paddle shifter (17), paddle shifter support (20), hammering gear paddle shifter (23), tension spring (12) and paddle shifter spring (21) are installed on the guide pillar (25) in order. The stop plate (14) is provided with a stop tooth to match heel teeth (3) of bull gear and is positioned at one side of knob (26). The other side of drilling gear paddle shifter (17) is connected to paddle shifter support (20). A tension spring (21) is provided between drilling gear paddle shifter (17) and paddle shifter support (20). The other side of paddle shifter support (20) is snapped on hammering gear paddle shifter (22). The paddle shifter spring (24) is provided between paddle shifter support (20) and hammering gear paddle shifter (22). The paddle shifters of drilling gear paddle shifter (17) are correspondingly provided on the each side of gear clutch (8) to clamp gear clutch (8). The hammering gear fork of hammering gear paddle shifter (22) is correspondingly provided in the slot of hammering gear clutch (9).

The knob (26) is provided with elliptical paddle shifter (27) diverged from center of knob on one side. An elliptical paddle shifter (27) is provided between paddle shifter support (20) and hammering gear clutch (9), and also provided with a quadrant lug (28) and a semicircular lug (29) on the other side. With its outer edge supporting the positioning plate of stop plate (14).

Needle radial positioning is adopted between the torque clutch and the rotary bush. The bull gear is movably fitted with the rotary bush. The torque clutch and bull gear are provided with mating concave convex grooves integrally. If torque clutch skids from bull gear, failing to transfer the rotating force to rotary bush assembly, drill will stop for overload protection. After the load is lightened, electrical hammer will restore normal work.

Reference will now be made in greater detail to exemplary embodiments of five functions of the present invention with reference to the accompanying drawings.

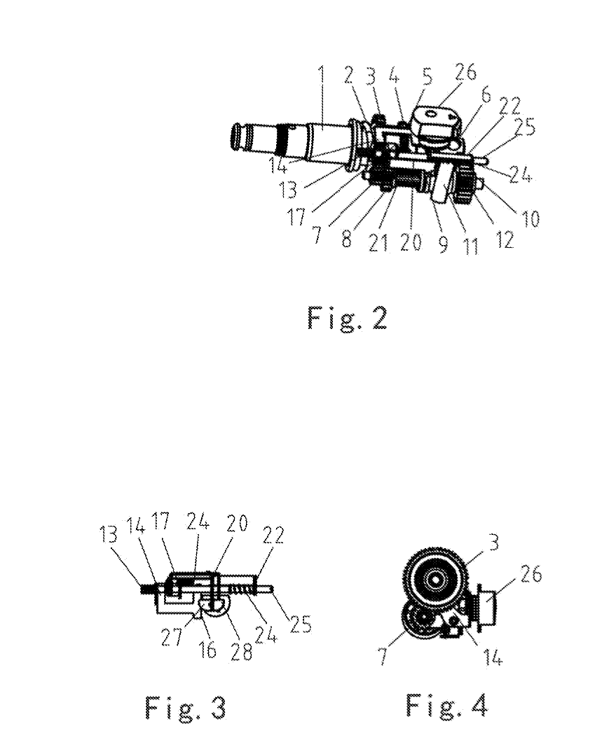

The structure of hammer drilling of the present invention is shown in the FIG. 2 and FIG. 3. The elliptical paddle shifter (27) and quadrant lug (28) are clamped between paddle shifter support (19) and hammering gear paddle shifter (22). An external dome of semicircular lug (29) supports the positioning plate (16) of stop plate (14). A tooth blade (15) of stop plate (14) is disengaged from heel teeth (3) of bull gear while pinion (7) is engaged with the heel teeth (3) of bull gear. Actuated by drilling gear fork (18) of drilling gear paddle shifter (17), one end of gear clutch (8) is engaged with the teeth of middle shaft (10) and the other end engages with pinion (7). Actuated by the hammering gear fork (23) of hammering gear paddle shifter (20), the internal tooth of hammering gear clutch (9) is engaged with the teeth of middle shaft (10). The hammering gear clutch (9) is connected to swing rod bearing (11) through mating convexo-concave groove (31,32). During operation, motor output shaft drives primary gear (12) and consequently primary gear (12) drives middle shaft (10). Middle shaft (10) drives rotary bush assembly (1) through gear clutch (8), pinion (7), heel teeth (3) of bull gear and torque clutch (5) to transfer rotating force. Middle shaft (10) drives swing rod bearing (11) through hammering gear clutch (9). Swing rod bearing (11) drives the reciprocation of cylinder assembly (6) to impel air hammer of cylinder assembly (6) to strike hammer, transferring impact energy to realize hammer drilling function of electrical hammer.

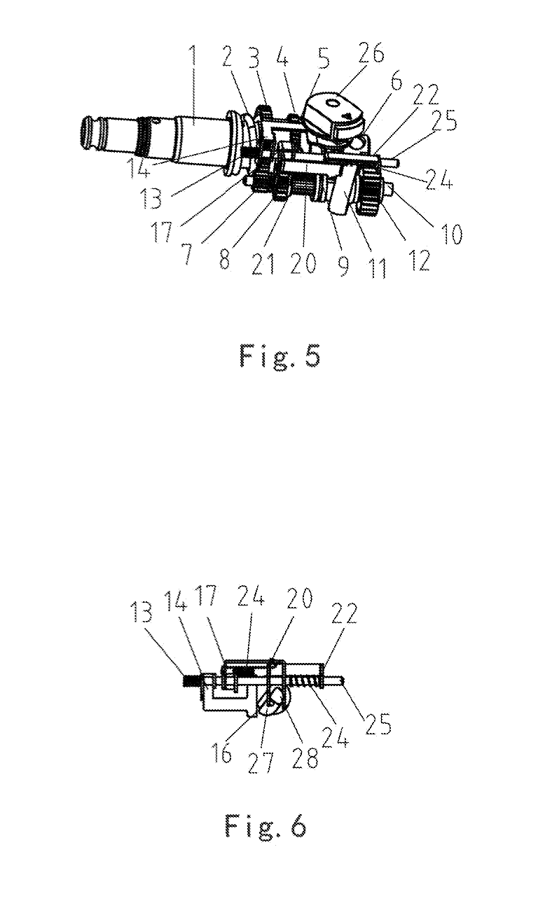

The structure of single hammer angle adjustment is shown in FIG. 5. When the knob (26) is switched to single hammer angle adjustment in downtime as shown in the FIG. 6, positioning plate (16) of stop plate (14) will contact semicircular surface of semicircular lug (29) on the knob (26). Rotation radius of knob (26) and the position of stop plate (14) remain unchanged. Teeth (15) of stop plate (14) remain separated with heel teeth (3) of bull gear. Rotation radius of the contact surface between quadrant lug (28) and hammering gear paddle shifter (22) remains unchanged, and hammering gear paddle shifter (22) also remains unmoved. Hammering gear clutch (9) is connected to swing rod bearing (11) through mating convexo-concave groove (31, 31). Now change occurs to elliptical paddle shifter (27) and rotation radius of paddle shifter support (19). Elliptical paddle shifter (27) deviating from rotation center drives paddle shifter support (19) to move to the right, and consequently paddle shifter support (19) drives drilling gear paddle shifter (17) and gear clutch (8) to move to the right and is disengaged from pinion (7). Now pinion (7), heel teeth (3) of bull gear, torque clutch (5) and rotary bush assembly (1) are in neutral transmission, rotary bush assembly (1) can easily adjust the angle of drills to realize function of single hammer angle adjustment of electrical hammer.

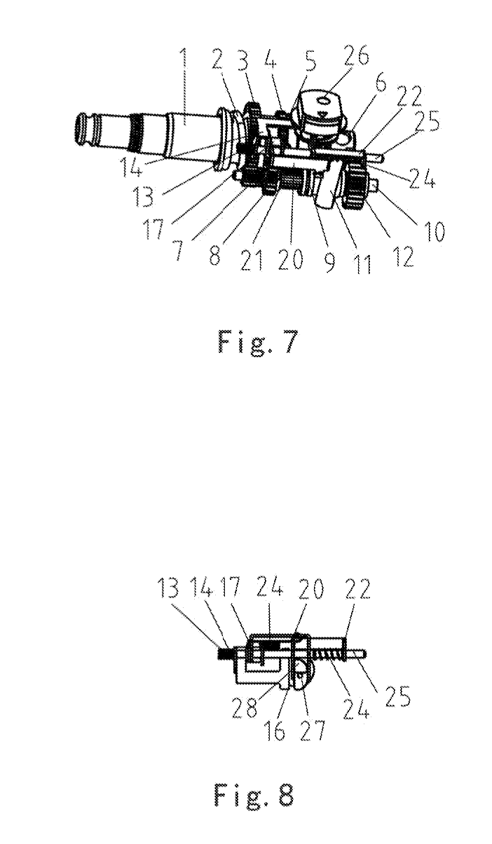

The structure of single hammer is shown in the FIG. 7. When the knob (26) is switched to single hammer as shown in the FIG. 8, positioning plate (16) of stop plate (14) will contact semicircular surface of semicircular lug (29) on the knob (26). Rotation radius of knob (26) is the minimum. Tooth blade (15) of stop plate (14) is engaged with heel teeth (3) of bull gear. Rotation radius of the contact surface between quadrant lug (28) and hammering gear paddle shifter (22) remains unchanged, and hammering gear paddle shifter (22) also remains unmoved. Hammering gear clutch (9) is connected to swing rod bearing (11) through mating convexo-concave groove (31, 31). Now change occurs to elliptical paddle shifter (27) and rotation radius of paddle shifter support (19). Elliptical paddle shifter (27) deviating from rotation center drives paddle shifter support (19) to move to the right, and consequently paddle shifter support (19) drives drilling gear paddle shifter (17) and gear clutch (8) to move to the right and is disengaged from pinion (7). Now pinion (7), heel teeth (3) of bull gear, torque clutch (5) and rotary bush assembly (1) are in neutral transmission. During operation, motor output shaft drives primary gear (12) and consequently primary gear (12) drives middle shaft (10). Since gear clutch (8) is separated completely from pinion (7), pinion (7) does not transfer rotating force, and heel teeth (3) of bull gear, torque clutch (5) and rotary bush assembly (1) do not rotate and cannot realize the function of drilling. Middle shaft (10) drives swing rod bearing (11) through hammering gear clutch (9). Swing rod bearing (11) drives the reciprocation of cylinder assembly (6) to impel air hammer of cylinder assembly (6) to strike hammer, transferring impact energy to realize the function of single hammering of electrical hammer. Tooth of stop plate is engaged with heel teeth of bull gear to lock rotary bush and to prevent the rotary bush from rotating, thus ensuring the angles of drills unchanged at hammering.

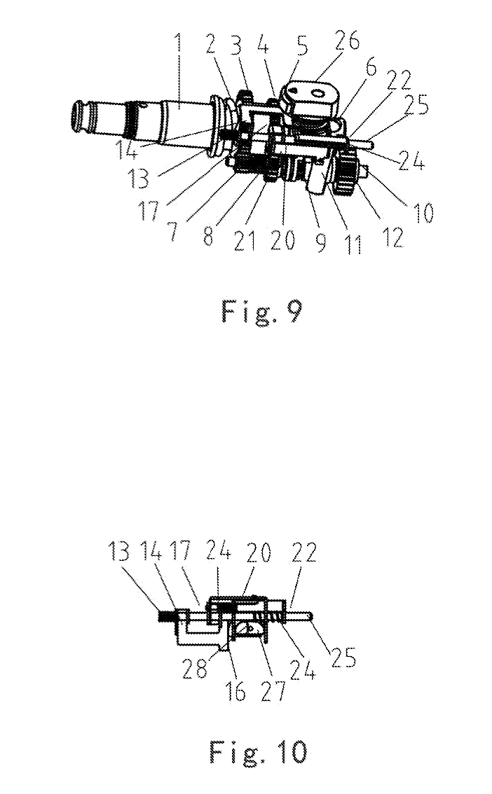

FIG. 9 shows the state when the knob is switched to single drill 2, and its structure is shown in FIG. 10. Positioning plate (16) of stop plate (14) contacts with semicircular surface of semicircular lug (29) on the knob (26). Rotation radius of knob (26) is the maximum. The position of stop plate (14) is the same as that for hammer drilling. Tooth blade (15) of stop plate (14) is separated from heel teeth (3) of bull gear. Pinion (7) is separated from gear clutch (8) and heel teeth (3) of bull gear. Now change occurs to the contact surface of paddle shifter support (19) and the rotation radius of elliptical paddle shifter (27) of the knob (26). The knob (26) is the maximum. Elliptical paddle shifter (27) deviating from rotation center drives paddle shifter support (19) to move to the right, and consequently paddle shifter support (19) drives gear clutch (8) and drilling gear paddle shifter (17) to move to the right. Tensioned by the tension spring (21) between paddle shifter support (19) and drilling gear paddle shifter (17), the outer tooth of gear clutch (8) is engaged with toe tooth (4) of bull gear. Gear clutch (8) is disengaged from pinion (7). Now change occurs to the rotation radius of contact surface between quadrant lug (28) and hammering gear paddle shifter. Hammering gear paddle shifter (22) moves to the left. Hammering gear fork (23) drives hammering gear clutch (9) to separate from mating the convexo-concave groove (31, 32) of swing rod bearing. During operation, motor output shaft drives primary gear (12) and consequently primary gear (12) drives middle shaft (10). Middle shaft (10) drives rotary bush assembly (1) through gear clutch (8), toe teeth (4) of bull gear and torque clutch (5) to transfer rotating force. Since hammering gear clutch (9) is separated completely from swing rod bearing (11), swing rod bearing (11) does not drive the reciprocation of cylinder assembly (6). The air hammer does not perform the function of hammering but realize the function of single drill 2.

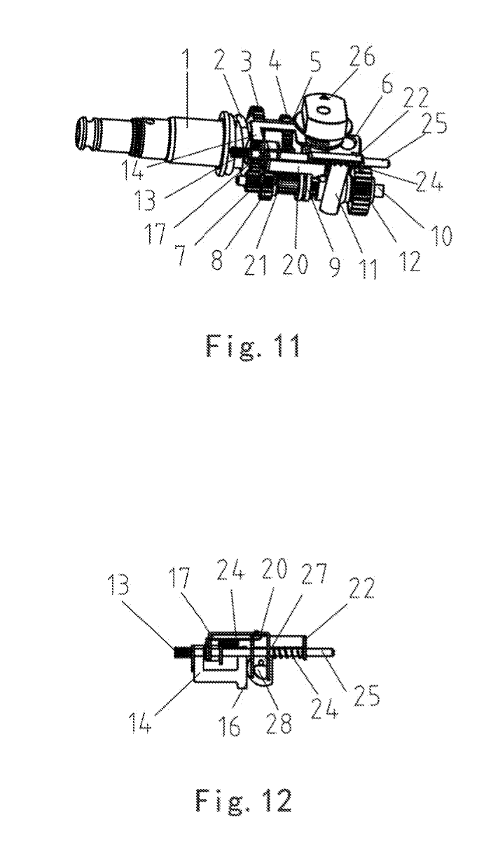

FIG. 11 shows the state when the knob is switched to single drill 1, and its structure is shown in FIG. 12. Positioning plate (16) of stop plate (14) contacts with semicircular surface of semicircular lug (29) on the knob (26). Rotation radius of knob (26) is the maximum. The position of stop plate (14) is the same as that for hammer drilling. Tooth blade (15) of stop plate (14) is separated from heel teeth (3) of bull gear. Actuated by drilling gear fork (18) of drilling gear paddle shifter (17), one end of gear clutch (8) is engaged with the teeth of middle shaft (10) and the other end is engaged with pinion (7). Pinion (7) is separated from toe teeth (4) of bull gear. Now change occurs to the rotation radius of contact surface between elliptical paddle shifter (27) of the knob (26) and paddle shifter support (19). Rotation radius of knob (26) is reduced. The position of paddle shifter support (19) is the same as that for hammer drilling. Tensioned by the tension spring (21) between paddle shifter support (19) and drilling gear paddle shifter (17), the outer tooth of gear clutch (8) is engaged with heel tooth (3) of bull gear. Rotation radius of the contact surface between quadrant lug (28) and hammering gear paddle shifter (22) remain unchanged. The position of hammering gear paddle shifter (22) is the same as that for single drilling 2. Hammering gear fork (23) of hammering gear paddle shifter (22) drives hammering gear clutch (9) to disengage from mating convexo-concave groove (31, 32). During operation, motor output shaft drives primary gear (12) and consequently primary gear (12) drives middle shaft (10). Middle shaft (10) drives rotary bush assembly (1) through gear clutch (8), pinion (7), heel teeth (3) of bull gear and torque clutch (5) to transfer rotating force. Since hammering gear clutch (9) is separated from swing rod bearing (11), swing rod bearing (11) does not drive the reciprocation of cylinder assembly (6). The air hammer of cylinder assembly (6) does not perform the function of hammering but realize the function of single drill 1.

1: A light single-button multifunctional electric hammer, comprising a hammer body, a motor, a rotary bush assembly, a cylinder assembly, a fork assembly and knobs; wherein the motor, rotary bush assembly, cylinder assembly and fork assembly are installed in the hammer body; the knobs and paddle shifter assembly are interlocked; the light single-button multifunctional electric hammer also comprises a bull gear and a transmission mechanism, the bull gear comprises heel teeth and toe teeth; the heel teeth take the form of heel multi gear, the toe teeth take the form of toe few gear, the torque clutch transmission gear comprises a pinion, gear clutch, middle shaft, hammering gear clutch, swing rod bearing and a primary gear, the pinion and middle shaft fit movably; the pinion is engaged with the heel teeth of the bull gear and is engaged with inner gear of the gear clutch; the gear clutch is fitted with the toe teeth of the bull gear and middle shaft; the gear clutch and hammering gear clutch running are fitted with the middle shaft; the swing rod bearing is dynamically fitted with the middle shaft and is connected to cylinder assembly through the swing rod; the hammering gear clutch and the swing rod bearing are provided with mating concave convex grooves, and the primary gear and the middle shaft fit closely; the knob is connected to operating mechanism; the operating mechanism is fitted with heel teeth of bull gear, gear clutch and hammering gear clutch.

2: The light single-button multifunctional electric hammer as set forth in claim 1, wherein the operating mechanism comprises a stop plate spring, a stop plate, a drilling gear paddle shifter, a paddle shifter support, inner knobs, a hammering gear paddle shifter, a tension spring, a paddle shifter spring and a guide pillar; the stop plate spring, stop plate, drilling gear paddle shifter, paddle shifter support, hammering gear paddle shifter and tension spring are installed on the guide pillar in order; the stop plate is provided with stop teeth to match heel teeth of bull gear and is positioned on one side of inner knob; the other side of drilling gear paddle shifter is snapped on the paddle shifter support; a tension spring is provided between drilling gear paddle shifter and paddle shifter support; the other side of paddle shifter support is snapped on the hammering gear paddle shifter; a paddle shifter spring is provided between paddle shifter support and hammering gear paddle shifter; the paddle shifters of drilling gear paddle shifter are provided correspondingly on each side of gear clutch to clamp gear clutch; the hammering gear fork of hammering gear paddle shifter is provided correspondingly in the groove of hammering gear clutch.

3: The light single-button multifunctional electric hammer as set forth in claim 2, wherein the knob is provided on one side with an elliptical paddle shifter diverged from knob center; the elliptical paddle shifter is provided between paddle shifter support and hammering gear clutch, and also provided with a quadrant lug; a semicircular lug is provided on the other side with its outer edge supporting the positioning plate of stop plate.
